(19) United States
(12) Patent Application Publication
(10) Pub. No.: US 2025/0138858 A1
(43) Pub. Date: May 1, 2025

(54) RUNTIME LOADING OF NON-NATIVE MODULES IN VIRTUAL MACHINES

(71) Applicant: RED HAT, INC., Raleigh, NC (US)

(72) Inventors: Edoardo Vacchi, Milano (IT); Luca Burgazzoli, Piacenza (IT)

(21) Appl. No.: 18/498,320

(22) Filed: Oct. 31, 2023

(51) Int. Cl. G06F 9/455

(52) U.S. Cl. CPC G06F 9/45558

(57) ABSTRACT

Systems and methods for runtime loading of a non-native module to a virtual machine. An example method may include running, by a processing device, a virtual machine; loading, in the virtual machine, a first bytecode module comprising a first bytecode of a first bytecode type, wherein the first bytecode type is not supported by the virtual machine; validating the first bytecode module according to a first validation policy based on a status of the virtual machine; generating a second bytecode module by translating the first bytecode to a second bytecode of a second bytecode type, wherein the second bytecode type is supported by the virtual machine; and executing the second bytecode module by the virtual machine.

### TECHNICAL FIELD

Embodiments of the present disclosure relate to virtualization systems, and more specifically, relate to runtime loading of non-native modules to virtual machines.

### BACKGROUND

A Java Virtual Machine (JVM) is a virtual machine that enables a computer to execute Java programs as well as programs written in other languages that are also compiled to Java bytecode.

WebAssembly (sometimes abbreviated Wasm) defines a portable binary-code format and a corresponding text format for executable programs as well as software interfaces for facilitating interactions between such programs and their host environment.

### BRIEF DESCRIPTION OF THE DRAWINGS

Disclosure is illustrated by way of example, and not by way of limitation, and may be more fully understood with references to the following detailed description when considered in connection with the figures, in which:

FIG. 1A illustrates a high-level component diagram of an example architecture for a virtualization system, in accordance with one or more aspects of the present disclosure.

FIG. 1B illustrates an example system for runtime loading of a bytecode module to a virtual machine, in accordance with one or more aspects of the present disclosure.

FIG. 2 is a flow diagram of an example method for runtime loading of a bytecode module to a virtual machine, in accordance with embodiments of the present disclosure.

FIG. 3 is a block diagram of an example system for runtime loading of a bytecode module to a virtual machine, in accordance with embodiments of the present disclosure.

FIG. 4 is a block diagram illustrating a computing system in which implementations of the disclosure may be used.

### DETAILED DESCRIPTION

Described herein are methods and systems for runtime loading of a non-native module to a virtual machine. Managed computer systems allow an application (e.g., represented by one or more executable files produced by a build process) to be executed on any platform regardless of the underlying hardware or operating system (e.g., virtual machine, such as the Java™ Virtual Machine (JVM)). Applications that are written in a non-native programming language (e.g., a Java application) contain source files (e.g., .java files) that are compiled into virtual machine-readable bytecode (e.g., class files) which may have a .class extension. In some implementations, class files may be organized into logical groups (e.g., modules) which may be represented as .jar files.

WebAssembly is a bytecode (non-native) format for a virtual machine to provide a portable compilation environment. WebAssembly allows arbitrary codes to be compiled into WebAssembly bytecode. The WebAssembly bytecode is then translated into native machine code and executed. WebAssembly is generally lightweighted and use less resources such as memory (e.g., because of no garbage collection) than JVM. WebAssembly also provides an isolated execution model, and WebAssembly applications cannot be accessed directly by processes outside of the isolated execution model, which can make the environment safter than JVM. WebAssembly use WebAssembly System Interface (WASI) to provide controlled access to files, networking, system clock, and other system services needed in programs. However, there is no efficient way to run programs that have been developed and complied for WebAssembly in platform such as widely-used JVM during the runtime of JVM.

Aspects of the present disclosure address the above-noted and other deficiencies by providing methods and systems for runtime loading of a bytecode module including the bytecode(s) of a first bytecode type (such as WebAssembly bytecode) to a virtual machine supporting a second bytecode type (such as Java bytecode), where the first bytecode type is not supported by the virtual machine. Specifically, during the runtime of the virtual machine, the virtual machine receives a request to execute the module including the bytecode of the first bytecode type that is not supported by the virtual machine. In response, the virtual machine loads the module and performs validation of the module. The virtual machine then translates the module into the bytecode of the second bytecode type that is supported by the virtual machine, and executes the translated module.

In an illustrative example, the virtual machine is a JVM, while the module is written in WebAssembly bytecodes. The JVM, during the runtime, may receive a request of the module, and in response, use a runtime loading and translating component to load the module written in the WebAssembly bytecode in the JVM and validate the module. The validation of the loaded module may be performed according to a specification, a static validation policy (e.g., including configuration files), and/or a dynamic validation policy (e.g., based on the status of the system). The runtime loading and translating component may translate the module written in the WebAssembly bytecode to a module in Java bytecode. The module written in the WebAssembly bytecode may include a set of WebAssembly bytecode instructions, and each WebAssembly bytecode instruction is translated to a corresponding Java bytecode instruction. Thereafter, the JVM may execute, during the runtime of JVM, the translated module. For example, executing the translated module may require one or more Java class files, and the runtime loading and translating component can load the Java class files into a storage of the virtual machine and have an execution engine to execute the translated module using the loaded class files.

In some implementations, the JVM may receive the request from a Java application running on the JVM, and the JVM may send the result of executing the translated module to the Java application. In some implementations, the JVM may receive the request from a WebAssembly application running on the JVM or running outside the JVM, and the JVM may send the result of executing the translated module to the WebAssembly application.

Accordingly, aspects of the present disclosure improves efficiency of running a module including bytecodes of the first bytecode type that is not supported by the virtual machine during the runtime of the virtual machine. Also, aspects of the present disclosure improve the efficiency of translation of the module including bytecodes of the first bytecode type to bytecodes of the second bytecode type, when compared with an offline compiler that is separate from virtual machine or compared with online interpreting instructions one by one. Further, aspects of the present disclosure do not need to use native libraries, for example, through a Java Native Interface, or concern the boundary between the non-native bytecodes and the native machine code in the native libraries. Moreover, the validation performed according to the present disclosure allows flexibility and customization in the validation policies.

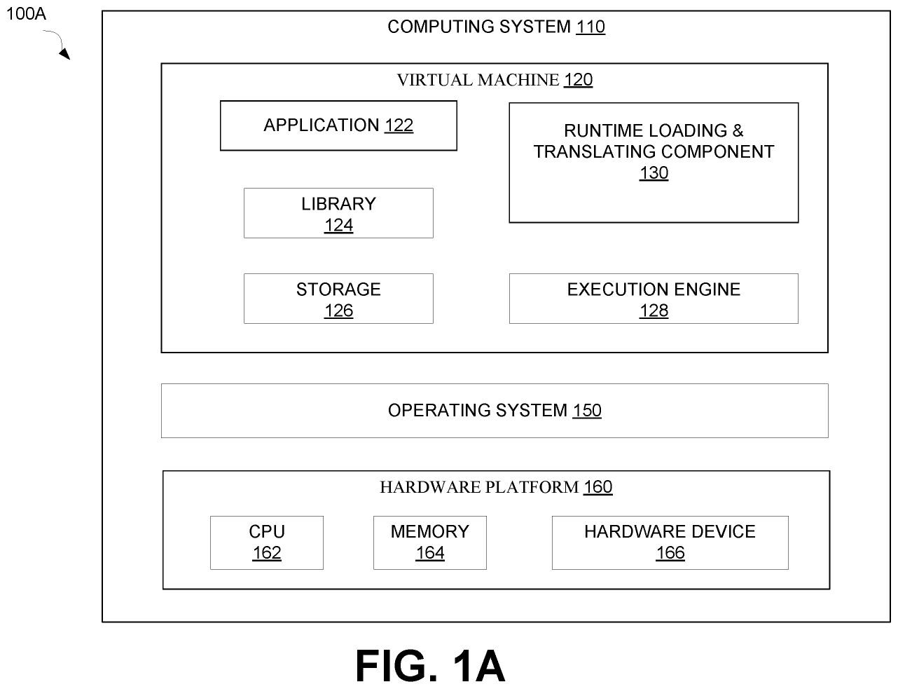

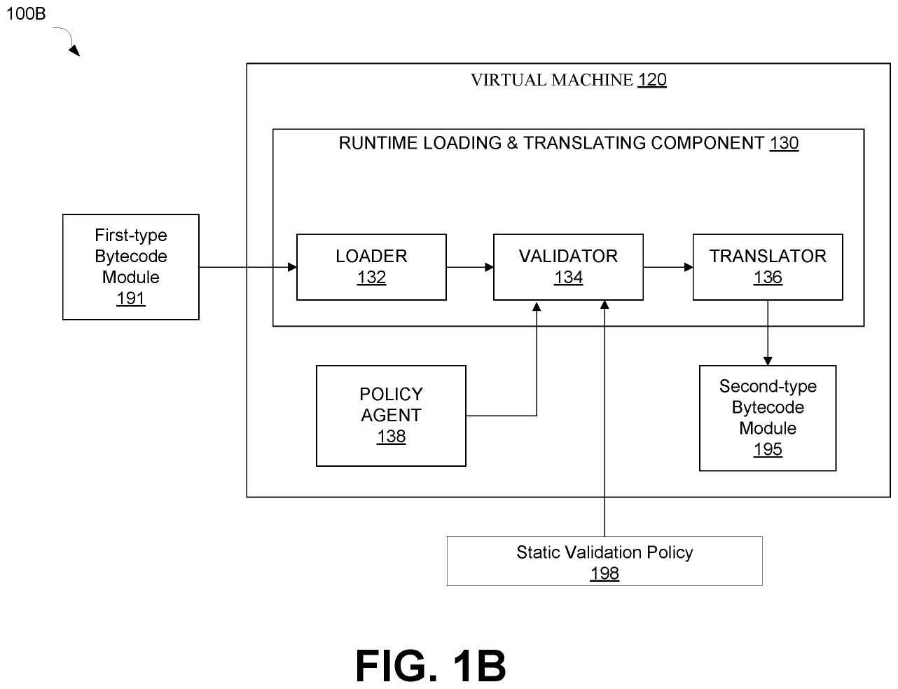

FIG. 1A illustrates a virtualization system 100A in which embodiments of the present disclosure may operate. It should be noted that other architectures for virtualization system 100A are possible, and that the implementation of a virtualization system 100A utilizing embodiments of the disclosure are not necessarily limited to the specific architecture depicted by FIG. 1A.

Virtualization system 100A may include a computing system 110 which can include a hardware platform 160, an operating system 150 that executes on the hardware platform 160 and a virtual machine 120.

Computing system 110 may be a server, a server cluster, a workstation, a personal computer (PC), a mobile device, a tablet computer, a laptop computer, or any other device, machine, or cluster of machines capable of hosting a virtual machine. The computer system 100 can be communicably connected to a network (not shown), such as a private network (e.g., a local area network (LAN), wide area network (WAN), intranet, etc.) or a public network (e.g., the Internet). Operating system (OS) 150 may be a Microsoft® Windows® OS, Linux® OS, Solaris® OS, Android® PS, Apple® iOS®, etc.

Hardware platform 160 may include one or more central processing units (CPU) 162, memory 164 and at least one hardware device 166. Examples of hardware devices 166 include network interface cards (NICs), sound or video adaptors, photo/video cameras, printer devices, keyboards, displays or any other suitable device intended to be coupled to a computer system.

Virtual machine 120 can be implemented to run on any operating system 150, and can also be implemented to run directly on any hardware platform 160. The virtual machine 120 may be a portion of software that can execute platform-independent bytecode in any programming language. Virtual machine 120 can translate bytecode into executable instructions at runtime (e.g., on the fly) and immediately executes the instructions. Bytecode can be code in a standardized portable binary format that may be used, for example, to create an application 122. Bytecode can have the form of one or more class files (e.g., Java class files) and is executed by the virtual machine 120. Bytecode can be packaged into logical groups, such as modules. A module may define another module for which the module depends and so on. Module dependency may result in a declaration that one module requires the bytecode files of another module in order to function.

In some implementations, the virtual machine 120 can be a Java Virtual Machine (JVM) that can execute bytecode in various programming language (e.g., Java, Armed Bear Common Lisp, Clojure, Erjang, Fantom, Free Pascal, Gosu, Groovy, Jacl, JavaFX Script, JRuby, Jython, Kotlin, NetRexx, Processing, Quercus, Rhino, Scala, etc.). In one implementation, JVM can execute an application 122 including Java bytecode such as a Java class file, where the Java class file contains Java bytecode that can be executed on the JVM. Application 122 may include one or multiple Java class files. In one implementation, JVM can execute an application 122 comprised of WebAssembly bytecode such as a WebAssembly .wat file, where the WebAssembly .wat file contains WebAssembly bytecode that cannot be executed on the JVM. In one implementation, the application 122 can be external to the virtual machine 120.

The virtual machine 120 can include a bytecode library 124, an allocated storage 126, a runtime loading and translating component 130, and an execution engine 128. Bytecode library 124 is a collection of bytecode (e.g., class files, etc.). Bytecode library 124 may be a dynamic loadable library that application 122 can call at runtime. The bytecode library 124 can provide the virtual machine 120 a well-known set of functions to perform common tasks. When the virtual machine 120 is instantiated, the bytecode library 124 can be loaded with a default set of standard bytecode (e.g., a default set of class files). In one implementation, the virtual machine is a JVM, the bytecode library 124 is a Java class library.

The runtime loading and translating component 130 may receive a request of executing a module written in a bytecode that is not supported by the virtual machine 120. In some implementations, the request specifies to execute a module including the bytecode(s) of the first bytecode type, while the virtual machine 120 cannot execute the bytecode(s) of the first bytecode type. In some implementations, the request is received through the application 122. In some implementations, the runtime loading and translating component 130 may determine that the module is not supported by the virtual machine 120.

Upon receiving the request, the runtime loading and translating component 130 may load the module including the bytecode(s) of the first bytecode type in the virtual machine 120 and perform a validation on the module. Upon validating the module, the runtime loading and translating component 130 may translate the module to a module in the second bytecode type. Upon translating the module, the runtime loading and translating component 130 can store, during the runtime, the translated module in the allocated storage 126 for execution. The detail of the functionality of operations of runtime loading and translating component 130 is described below with respect to FIG. 1B.

The runtime loading and translating component 130 may enable the execution engine 128 to execute the translated module. In some implementations, the execution engine 128 may receive the bytecode instructions in the translated module and execute the bytecode instructions encoding arithmetic, logical, or I/O operations. In some implementations, the runtime loading and translating component 130 may include a just-in-time (JIT) compiler capable of compiling some bytecode instructions in the translated module to the native machine code instruction at the runtime to improve the performance.

In some implementations, the request is received through the application 122, and the virtual machine 120 may return the result of executing the translated module to the application 122, where the application 122 can be an application using bytecodes in the second bytecode type (e.g., a Java application) or an application using bytecodes in the first bytecode type (e.g., WebAssembly application) running on the virtual machine 120 or running outside the virtual machine 120.

FIG. 1B illustrates an example system 100B in which embodiments of the present disclosure may operate. It should be noted that other architectures for system 100B are possible, and that the implementation of system 100B utilizing embodiments of the disclosure are not necessarily limited to the specific architecture depicted by FIG. 1B. The example system 100B may include the virtual machine 120 that includes the runtime loading and translating component 130 as described in FIG. 1A. The runtime loading and translating component 130 may include a loader 132, a validator 134, and a translator 136. The virtual machine 120 may further include a policy agent 138. To ease the description of an example, the module comprising bytecode(s) of the first bytecode type that is not supported by the virtual machine is described as the first-type bytecode module 191 (e.g., WebAssembly bytecode module), and the translated module in bytecode(s) of the second bytecode type that is supported by the virtual machine is described as the second-type bytecode module 195 (e.g., Java bytecode module).

The loader 132 may receive a request for loading a module (e.g., first-type bytecode module 191). The loader 132 may determine whether the module is a module comprising bytecode(s) of the first bytecode type that is not supported by the virtual machine 120. By examining the bytecode information specified in the request, the loader 132 may determine that the module (e.g., first-type bytecode module 191) is not supported by the virtual machine 120. For example, the request may include a bytecode type identifier of the module, and the loader 132 may search a file including supported bytecode type information in the virtual machine 120 for a match of the bytecode type identifier. Responsive to not finding a match of bytecode type identifier of the module, the loader 132 may determine that the module is not supported by the virtual machine 120. The loader 132 may then send the loaded module (e.g., first-type bytecode module 191) to the validator 134 for validation.

The validator 134 may perform a validation of the loaded module (e.g., first-type bytecode module 191) according to a specification, a static validation policy, and/or a dynamic validation policy. The validation of the loaded module aims to ensure that properly formed data is entering the virtual machine 120, including the structure and form of the data and the meaning assigned to the data. For example, the specification may include the system requirements to load a module. As another example, the specification may define over the abstract syntax of a module and its contents, and may include a typing rule (e.g., in intuitive form or in mathematical form) that specifies the constraints that apply to each piece of abstract syntax. As yet another example, the specification may define functions, tables, memories, and/or global variables declared in the module.

The validator 134 may be implemented as code written to perform analysis over static or dynamic validation polices. The static validation policies refer to polices declaring the set of capabilities that the module can request, where defining these capabilities does not need to run the code. The dynamic validation policies refer to polices declaring the set of capabilities that the module can request, where defining these capabilities needs to run the code. The validator 134 may analyze the module according to the rules included in static and/or dynamic validation polices, and the result of analysis may indicate whether to accept the module (i.e., the module is validated) or reject the module (i.e., the module is not validated).

In some implementations, the static validation policy may include configuration files, where each configuration file may represent a set of rules to configure the parameters and settings of the system and thus define the structures, forms, or values of data that can be included in the module. In one example, the configuration files include a rule of security that defines the maximum number of the instructions that can be included in the module. As another example, the configuration file may be specific to a software library and may provide a configuration mechanism to enable or disenable a configuration flag for network support. As yet another example, the configuration file may include a security policy to disallow accepting incoming network connections or disallow writing to disk.

In some implementations, the static validation policy can be retrieved from a data store including the static validation policy 198. In one example, the static validation policy 198 may be provided by a third party. For example, the third party may be a service provider that provides a cloud service to end users and allows the end user to customize the cloud service. The third party may provide a validation policy that can control over the type of resources that can be consumed (e.g., network, file/disk access, etc.) by the end users and the system state that the cloud service would run in (e.g., limits on the execution time, limits on the number of instructions, etc.).

In some implementations, the dynamic validation policy may include the validation policy that can be only determined dynamically, such as system properties depending on the execution flow of a running application. The dynamic validation policy may include a set of rules that define the structures, forms, or values of data that can be included in the module according to a status of the system. The status of the system may be reflected by various values of parameters, where each parameter represents one or more system properties. For example, the status of the system may include a value representing the workload parameter. In one example, the status of the system may include a status of the virtual machine including, for example, the current tasks performed in the virtual machine. For example, the dynamic validation policy may include a rule to monitor an execution of a program that may run indefinitely (e.g., an infinite loop) and ensure that such execution does not occur. To implement, a global counter may be added to the program so that when a threshold value of the global counter is reached (e.g., 1000 counts), the program is terminated.

In some implementations, the dynamic validation policy may be provided by a policy agent 138 running on the virtual machine 120. For example, the policy agent 138 may monitor the system (e.g., network, memory, processor, etc.) for the status of the system and generate the dynamic validation policies according to the status of the system. In one example, under a workload that does not exceed a threshold workload value, the policy agent 138 may implement a policy that allows one or more modules performing certain amount of computations (e.g., over a threshold workload amount) over a certain time period (e.g., not over a threshold time period), while when the workload exceeds the threshold workload value, the policy agent 138 may implement a policy to limit one or more modules performing certain amount of computations (e.g., over a threshold workload amount) over a certain time period (e.g., not over a threshold time period).

In some implementations, the validation of the loaded module may involve modifying bytecode in the loaded module. For example, if a validation policy includes a security policy to limit the number of instructions included in a module, the validator 134 may modify the module by adding a counter to count the instructions and a mechanism to terminate the process if the counter reaches the limit. As such, the validator 134 may modify bytecode and/or generate customized bytecode (e.g., inserting the instruction counters that are not present in the original bytecode).

Upon validating the loaded module, the translator 136 may use a JVM plugin (e.g., Gradle Plugin) to translate the validated module from the bytecode of the first bytecode type to the bytecode of the second bytecode type. For example, the first-type bytecode module 191 may include a set of WebAssembly bytecode instructions, and each WebAssembly bytecode instruction is translated using the JVM plugin to a corresponding Java bytecode instruction. For example, the translator 136 may translate the instruction wasm i32.add to the instruction iadd on the JVM. The Java bytecode instructions may implement one or more Java classes.

Upon translating the module, the runtime loading and translating component 130 may load the files that are required for executing the translated module into the allocated storage 126. For example, executing the translated module may require one or more class files, and the runtime loading and translating component 130 may load one or more class files to the virtual machine 120 during the runtime. The runtime loading and translating component 130 may read the class file from the library 124 and save it in the allocated storage 126. For each class file, the runtime loading and translating component 130 stores the metadata (e.g., identifier of the class and its immediate parent class, variables and method information, etc.) in the allocated storage 126. In some implementations, the runtime loading and translating component 130 may include a bootstrap class loader, capable of loading standard core classes. In some implementations, the runtime loading and translating component 130 may include an extension class loader, which may be a child of the bootstrap class loader, capable of loading the classes present in the extension directories (an extension of the standard core classes). In some implementations, the runtime loading and translating component 130 may include system/application class loader, which is a child of the extension class loader, capable of loading classes from the application classpath.

Upon loading the second-type bytecode module 195, the runtime loading and translating component 130 may send the second-type bytecode module 195 to the execution engine 128 to execute the second-type bytecode module 195 during the runtime of the virtual machine 120.

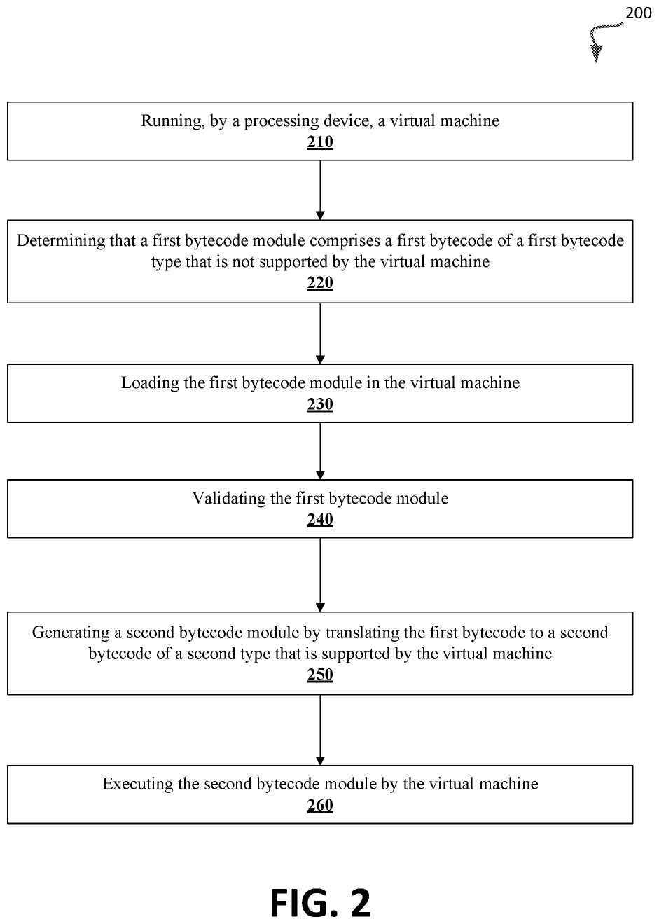

FIG. 2 depicts a flow diagram of an illustrative example of a method 200 for class loading of dependency class files using modified class identifiers, in accordance with one or more aspects of the present disclosure. Method 200 and each of its individual functions, routines, subroutines, or operations may be performed by one or more processors of the computer device executing the method. In certain implementations, method 200 may be performed by a single processing thread. Alternatively, method 200 may be performed by two or more processing threads, each thread executing one or more individual functions, routines, subroutines, or operations of the method. In an illustrative example, the processing threads implementing method 200 may be synchronized (e.g., using semaphores, critical sections, and/or other thread synchronization mechanisms). Alternatively, the processes implementing method 200 may be executed asynchronously with respect to each other.

For simplicity of explanation, the methods of this disclosure are depicted and described as a series of acts. However, acts in accordance with this disclosure may occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. Term “article of manufacture,” as used herein, is intended to encompass a computer program accessible from any computer-readable device or storage media. In one implementation, method 200 may be performed by a kernel of a hypervisor as shown in FIG. 1 or by an executable code of a host machine (e.g., host operating system or firmware), a virtual machine (e.g., guest operating system or virtual firmware), other executable code, or a combination thereof.

At block 210, the processing device may run a virtual machine. In some implementations, the virtual machine translates bytecode into executable instructions at runtime (e.g., on the fly) and immediately executes the instructions. In some implementations, virtual machine may be a portion of software that can execute platform-independent bytecode in a programming language (e.g., Java).

At block 220, the processing device may determine that a first bytecode module comprises a first bytecode of a first bytecode type that is not supported by the virtual machine. At block 230, the processing device may load the first bytecode module in the virtual machine. In some implementations, the processing device may receive a request for the first bytecode module, where loading the first bytecode module is performed responsive to receiving the request. In some implementations, the processing device may run an application that provides the request, wherein a result of executing the second bytecode module is returned to the application.

At block 240, the processing device may validate the first bytecode module. In some implementations, validating the first bytecode module is performed according to a specification. In some implementations, validating the first bytecode module is performed according to a static validation policy, wherein the static validation policy comprises a configuration file. In some implementations, validating the first bytecode module is performed according to a dynamic validation policy, where the dynamic validation policy is provided, by a running component monitoring the virtual machine, according to a status of the virtual machine. In some implementations, validating the first bytecode module further comprises modifying the first bytecode module according to a validation policy.

At block 250, the processing device may generate, in view of the validated bytecode module, a second bytecode module by translating the first bytecode to a second bytecode of a second bytecode type that is supported by the virtual machine. In some implementations, the processing device may load a class file included in the second bytecode module in a memory of the virtual machine. In some implementations, the first bytecode type comprises a type of a programming language designed to be used in a portable virtual machine. In some implementations, the second bytecode type comprise a type of a high-level, class-based, object-oriented programming language. At block 260, the processing device may execute the second bytecode module by the virtual machine.

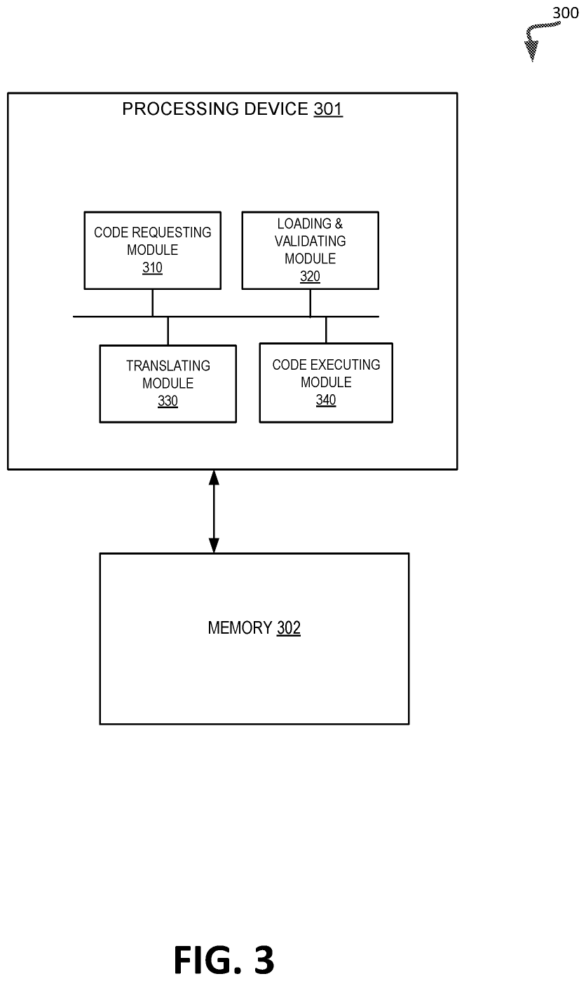

FIG. 3 depicts a block diagram of a computer system 300 operating in accordance with one or more aspects of the present disclosure. Computer system 300 may be the same or similar to computing system 110 of FIG. 1, and may include one or more processors and one or more memory devices. In the example shown, computer system 300 may include a code requesting module 310, a loading & validating module 320, a translating module 330, and a code executing module 340.

The code requesting module 310 may enable a processing device 301 to receive a request to execute a module comprising a bytecode of the first bytecode type that is not supported by the virtual machine during the runtime of the virtual machine. In some implementations, the bytecode of the first bytecode type is written in the WebAssembly bytecode, and the virtual machine supports the Java bytecode. In some implementations, the request may be received by an application, where the application can be an application of the second bytecode type (e.g., an application comprised of Java bytecode) or an application of the first bytecode type (e.g., an application comprised of WebAssembly bytecode) running on the virtual machine or running outside the virtual machine.

The loading & validating module 320 may enable the processing device 301 to determine that a bytecode module comprises a bytecode of a first bytecode type that is not supported by the virtual machine. In some implementations, by examining the bytecode information specified in the request, the code requesting module 310 may determine that the module comprises a bytecode of the first bytecode type is not supported by the virtual machine.

The loading & validating module 320 may enable the processing device 301 to load the bytecode module in the virtual machine and validate the bytecode module. The loading & validating module 320 may perform a validation of the loaded module according to one or more of the following: a specification, a static validation policy, or a dynamic validation policy. For example, the specification may include the system requirements to load a module. The static validation policy may include configuration files, for example, security configuration file. In some implementations, the static validation policy can be provided by a storage including the validation policy. The dynamic validation policy may include policies dynamically determined according to the status of the system (e.g., system properties of network, memory, processor, etc.).

In some implementations, the loading & validating module 320 may enable the processing device 301 to perform a validation of the loaded module by modifying bytecode in the loaded module. For example, if a validation policy includes a security policy to limit the number of instructions included in a module, the loading & validating module 320 may modify the module by adding a counter to count the instructions and a mechanism to terminate the process if the counter reaches the limit.

The translating module 330 may enable the processing device 301 to translate the module comprising the bytecode of the first bytecode type that is not supported by the virtual machine into a bytecode of the second bytecode type that is supported by the virtual machine. In some implementations, the translating module 330 translates the module written in the WebAssembly bytecode to a module of Java bytecode. For example, the translating module 330 may use a JVM plugin (e.g., Gradle Plugin) to translate from the WebAssembly bytecode to Java bytecode. The module written in the WebAssembly bytecode may include a set of WebAssembly bytecode instructions, and each WebAssembly bytecode instruction is translated to a corresponding Java bytecode instruction. The Java bytecode instructions may implement one or more Java classes.

The translating module 330 may enable the processing device 301 to store, during the runtime of the virtual machine, the translated module and load the required files into the memory 302. For example, the translated module may require one or more class files, and the loading module 330 loads one or more class files. The translating module 330 may reads the “.class” file, generate the corresponding binary data and save it in the memory 302.

The code executing module 340 may enable the processing device 301 to cause the translated module to execute in the virtual machine and return a result of the executing to the requestor. The translated module may include bytecode instruction encoding arithmetic, logical, or I/O operations.

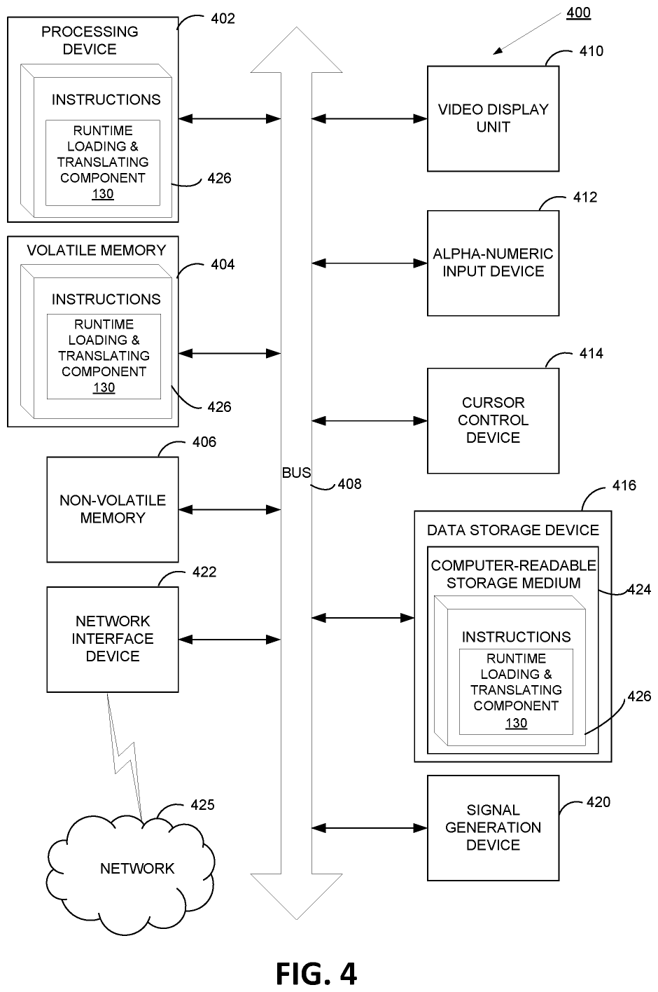

FIG. 4 is a block diagram illustrating a computer system in which implementations of the disclosure may be used. In some implementations, the computer system 400 may support secured peripheral device communication via a bridge device in virtualized computer systems, in accordance with previously described embodiments.

Computer system 400 may be included within a data center that supports virtualization. Virtualization within a data center results in a physical system being virtualized using VMs to consolidate the data center infrastructure and increase operational efficiencies. A VM may be a program-based emulation of computer hardware of the virtualized data center. For example, VM may operate based on computer architecture and functions of computer hardware resources associated with hard disks or other such memory. VM may emulate a physical computing environment, but requests for a hard disk or memory may be managed by a virtualization layer of a host machine to translate these requests to the underlying physical computing hardware resources. This type of virtualization results in multiple VMs sharing physical resources.

In certain implementations, computer system 400 may be connected (e.g., via a network, such as a Local Area Network (LAN), an intranet, an extranet, or the Internet) to other computer systems. Computer system 400 may operate in the capacity of a server or a client computer in a client-server environment, or as a peer computer in a peer-to-peer or distributed network environment. Computer system 400 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein for supporting manifest list for multi-platform application container images.

Computer system 400 includes a processing device 402, a volatile memory 404 (e.g., random access memory (RAM)), a non-volatile memory 406 (e.g., read-only memory (ROM) or electrically-erasable programmable ROM (EEPROM)), and a data storage device 416, which communicate with each other via a bus 408.

Processing device 402 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 402 may also be one or more special-purpose processing devices such as an application specific integrated circuit (ASIC), a field programmable gate array (FPGA), a digital signal processor (DSP), network processor, or the like. Processing device 402 is to execute the instructions 426 for performing the operations and steps discussed herein.

Computer system 400 may further include a network interface device 422 communicably coupled to a network 425. Computer system 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 420 (e.g., a speaker).

Instructions 426 may reside, completely or partially, within volatile memory 404 and/or within processing device 402 during execution thereof by computer system 400, hence, volatile memory 404 and processing device 402 may also constitute machine-readable storage medium 424.

Data storage device 416 may include a computer-readable storage medium 424 (e.g., a non-transitory computer-readable storage medium) on which may store instructions 426 encoding any one or more of the methods or functions described herein, including instructions for implementing method 200 of FIG. 2.

Non-transitory machine-readable storage medium 424 may also be used to store instructions 426 to support caching results of certain commands utilized for building multi-platform application container images described herein, and/or a software library containing methods that call the above applications. While the machine-accessible storage medium 424 is shown in an example implementation to be a single medium, the term “machine-accessible storage medium” should be taken to include a single medium or multiple media (e.g., a centralized or distributed database, and/or associated caches and servers) that store the one or more sets of instructions. Term “machine-accessible storage medium” shall also be taken to include any medium that is capable of storing, encoding or carrying a set of instruction for execution by the machine and that cause the machine to perform any one or more of the methodologies of the disclosure. Term “machine-accessible storage medium” shall accordingly be taken to include, but not be limited to, solid-state memories, and optical and magnetic media.

Unless specifically stated otherwise, terms such as “receiving,” “invoking,” “associating,” “providing,” “storing,” “performing,” “utilizing,” “deleting,” “initiating,” “marking,” “generating,” “transmitting,” “completing,” “executing,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

What is claimed is:

1. A method, comprising:
running, by a processing device, a virtual machine;
loading, in the virtual machine, a first bytecode module comprising a first bytecode of a first bytecode type, wherein the first bytecode type is not supported by the virtual machine;
validating the first bytecode module according to a first validation policy based on a status of the virtual machine;
generating a second bytecode module by translating the first bytecode to a second bytecode of a second bytecode type, wherein the second bytecode type is supported by the virtual machine; and
executing the second bytecode module by the virtual machine.

2. The method of claim 1, further comprising:
validating the first bytecode module according to a second validation policy comprising a configuration file.

3. The method of claim 1, further comprising:
validating the first bytecode module according to a specification.

4. The method of claim 1, further comprising:
monitoring the status of the virtual machine; and
generating the first validation policy.

5. The method of claim 1, wherein validating the first bytecode module further comprises:
modifying the first bytecode module according to a validation policy.

6. The method of claim 1, further comprising:
receiving, from a process, a request for the first bytecode module;
determining whether the first bytecode module comprises the first bytecode of the first bytecode type that is not supported by the virtual machine, wherein loading the first bytecode module is performed responsive to determining that the first bytecode module comprises the first bytecode of the first bytecode type that is not supported by the virtual machine; and
sending, to the process, a result of executing the second bytecode module.

7. The method of claim 1, wherein executing the second bytecode module further comprises:
loading a class file required by the second bytecode module in a memory of the virtual machine.

8. A system comprising:
a memory device;
a processing device, operatively coupled to the memory device, to perform operations comprising:
running a virtual machine;
loading, in the virtual machine, a first bytecode module comprising a first bytecode of a first bytecode type, wherein the first bytecode type is not supported by the virtual machine;
validating the first bytecode module according to a first validation policy based on a status of the virtual machine;
generating a second bytecode module by translating the first bytecode to a second bytecode of a second bytecode type, wherein the second bytecode type is supported by the virtual machine; and
executing the second bytecode module by the virtual machine.

9. The system of claim 8, wherein the operations further comprise:
validating the first bytecode module according to a second validation policy comprising a configuration file.

10. The system of claim 8, wherein the operations further comprise:
validating the first bytecode module according to a specification.

11. The system of claim 8, wherein the operations further comprise:
monitoring the status of the virtual machine; and
generating the first validation policy.

12. The system of claim 8, wherein validating the first bytecode module further comprises:
modifying the first bytecode module according to a validation policy.

13. The system of claim 8, wherein the operations further comprise:
receiving, from a process, a request for the first bytecode module;
determining whether the first bytecode module comprises the first bytecode of the first bytecode type that is not supported by the virtual machine, wherein loading the first bytecode module is performed responsive to determining that the first bytecode module comprises the first bytecode of the first bytecode type that is not supported by the virtual machine; and
sending, to the process, a result of executing the second bytecode module.

14. The system of claim 8, wherein executing the second bytecode module further comprises:
loading a class file required by the second bytecode module in a memory of the virtual machine.

15. A non-transitory machine-readable storage medium including instructions that, when executed by a processing device, cause the processing device to perform operations comprising:
running a virtual machine;
loading, in the virtual machine, a first bytecode module comprising a first bytecode of a first bytecode type, wherein the first bytecode type is not supported by the virtual machine;
validating the first bytecode module according to a first validation policy based on a status of the virtual machine;
generating a second bytecode module by translating the first bytecode to a second bytecode of a second bytecode type, wherein the second bytecode type is supported by the virtual machine; and
executing the second bytecode module by the virtual machine.

16. The non-transitory machine-readable storage medium of claim 15, wherein the operations further comprise:
validating the first bytecode module according to a second validation policy comprising a configuration file.

17. The non-transitory machine-readable storage medium of claim 15, wherein the operations further comprise:
validating the first bytecode module according to a specification.

18. The non-transitory machine-readable storage medium of claim 15, wherein the operations further comprise:
monitoring the status of the virtual machine; and
generating the first validation policy.

19. The non-transitory machine-readable storage medium of claim 15, wherein validating the first bytecode module further comprises: modifying the first bytecode module according to a validation policy.

20. The non-transitory machine-readable storage medium of claim 15, wherein the operations further comprise:
receiving, from a process, a request for the first bytecode module;
determining whether the first bytecode module comprises the first bytecode of the first bytecode type that is not supported by the virtual machine, wherein loading the first bytecode module is performed responsive to determining that the first bytecode module comprises the first bytecode of the first bytecode type that is not supported by the virtual machine; and
sending, to the process, a result of executing the second bytecode module.
